(19) United States
(12) Patent Application Publication
(10) Pub. No.: US 2024/0086576 A1
(43) Pub. Date: Mar. 14, 2024

(54) Stratified and Integrated Updatable Content Management System (SIU-CMS)

(71) Applicants: Janet Sobel, San Diego, CA (US); Steve Sobel, San Diego, CA (US)

(72) Inventors: Janet Sobel, San Diego, CA (US); Steve Sobel, San Diego, CA (US)

(21) Appl. No.: 18/452,428

(22) Filed: Aug. 18, 2023

Related U.S. Application Data
(60) Provisional application No. 63/374,403, filed on Sep. 2, 2022.

(51) Int. Cl. G06F 21/62; G06Q 30/0251

(52) U.S. Cl. CPC G06F 21/6254; G06Q 30/0255

(57) ABSTRACT

The present invention provides a device, system and method for managing delivering, curating and updating of content for users. The invention provides this utilization of a stratified and integrated content delivery method wherein multiple levels are incorporated. The multiple levels provide inherent update system decisions based on hierarchy that allow quick and effective delivery of content. The invention further allows the integration of various stakeholders with different needs in an effective manner.

### CROSS-REFERENCE

This application claims priority from the U.S. Provisional Patent Application with Ser. No. 63/374,403, entitled, “Stratified And Integrated Updatable Content Management System” filed on Sep. 2, 2022, which is incorporated herein by reference in its entirety.

### TECHNICAL FIELD

The present disclosure relates to a curated and secure content management system, method and device. More particularly, the disclosure relates to an improved curated and secure content management system with stratified architecture components with improved updating and storage methods.

### BACKGROUND

The Corporate Wellness industry is booming in response to the urgent need—across all professions—for quality content and solutions to address and alleviate the myriad maladies (physical, mental and spiritual) that come with the job. In the United States alone, the Corporate Wellness market size is valued at 18.4 billion dollars; expanding at a compound annual growth rate of 3.87%. The overall Wellness industry in the United States is likewise growing at breakneck speed, valued at over 450 billion dollars; expanding at a compound annual growth rate of 5%.

Currently, the area of Wellness Libraries—ones that would offer hubs of information and resources to help the various professions get better—is essentially non-existent. The key to offering digital solutions to the workforce that comprises these professional communities in the United States, is create a way to utilize the Wellness industry's plentiful marketing money to subsidize zero cost memberships for the employees of each profession, who need a Wellness Library that caters to that profession's specific needs. To facilitate the seamless transmission of the Wellness Library's content, along with a multitude of disparate advertisement spaces, from the Central Wellness Library to its associated subdomains, unique and proprietary technology, including a special content management system, is required to create a system that works efficiently and flawlessly.

### SUMMARY

Aspects and advantages of the invention will be set forth in part in the following description, or may be obvious from the description, or may be learned through practice of the invention.

In general, one innovative aspect of the subject matter described in this specification can be embodied in a centralized system comprising of a software platform comprising a primary level and a secondary level, wherein any changes or updates to the primary level are automatically applied to the entire secondary level, wherein the primary level comprises of a central entity, wherein the secondary level comprises of at least one subdomain, wherein the subdomains operate and act independently from all other subdomains, wherein content is stored within the central entity, and wherein access to the system is provided to a user with a user account.

In some embodiments, the invention includes a centralized system comprising of a software platform comprising a primary level and a secondary level, wherein any changes or updates to the primary level are automatically applied to the entire secondary level, wherein the primary level comprises of a central entity, wherein the secondary level comprises of at least one subdomain, wherein the subdomains operate and act independently from all other subdomains, wherein content is stored within the central entity, and wherein access to the system is provided to a user with a user account, wherein the access the user account has to the primary level and secondary levels is customizable.

In some embodiments, the invention includes a centralized system comprising of a software platform comprising a primary level and a secondary level, wherein any changes or updates to the primary level are automatically applied to the entire secondary level, wherein the primary level comprises of a central entity, wherein the secondary level comprises of at least one subdomain, wherein the subdomains operate and act independently from all other subdomains, wherein content is stored within the central entity, and wherein access to the system is provided to a user with a user account, wherein the access the user account has to the primary level and secondary levels is customizable, wherein the system includes a dashboard, wherein the access associated with the user account is shown on the dashboard.

In some embodiments, the invention includes a centralized system comprising of a software platform comprising a primary level and a secondary level, wherein any changes or updates to the primary level are automatically applied to the entire secondary level, wherein the primary level comprises of a central entity, wherein the secondary level comprises of at least one subdomain, wherein the subdomains operate and act independently from all other subdomains, wherein content is stored within the central entity, and wherein access to the system is provided to a user with a user account, wherein the system tracks and anonymizes all activity history of all user accounts in an individual manner.

In some embodiments, the invention includes a centralized system comprising of a software platform comprising a primary level and a secondary level, wherein any changes or updates to the primary level are automatically applied to the entire secondary level, wherein the primary level comprises of a central entity, wherein the secondary level comprises of at least one subdomain, wherein the subdomains operate and act independently from all other subdomains, wherein content is stored within the central entity, and wherein access to the system is provided to a user with a user account, wherein the system tracks and anonymizes all activity history of all user accounts in an individual manner, wherein the system further comprises sections designed to display advertisements to a user account as the system is accessed by the user account.

In some embodiments, the invention includes a centralized system comprising of a software platform comprising a primary level and a secondary level, wherein any changes or updates to the primary level are automatically applied to the entire secondary level, wherein the primary level comprises of a central entity, wherein the secondary level comprises of at least one subdomain, wherein the subdomains operate and act independently from all other subdomains, wherein content is stored within the central entity, and wherein access to the system is provided to a user with a user account, wherein the system tracks and anonymizes all activity history of all user accounts in an individual manner, wherein the system further comprises sections designed to display advertisements to a user account as the system is accessed by the user account, wherein the system selects advertisements to display to users and the selection is based on the user's individual activity history.

In some embodiments, the invention includes a centralized system comprising of a software platform comprising a primary level and a secondary level, wherein any changes or updates to the primary level are automatically applied to the entire secondary level, wherein the primary level comprises of a central entity, wherein the secondary level comprises of at least one subdomain, wherein the subdomains operate and act independently from all other subdomains, wherein content is stored within the central entity, and wherein access to the system is provided to a user with a user account, wherein the system tracks and anonymizes some of the activity history of the user account.

In some embodiments, the invention includes a centralized system comprising of a software platform comprising a primary level and a secondary level, wherein any changes or updates to the primary level are automatically applied to the entire secondary level, wherein the primary level comprises of a central entity, wherein the secondary level comprises of at least one subdomain, wherein the subdomains operate and act independently from all other subdomains, wherein content is stored within the central entity, and wherein access to the system is provided to a user with a user account, wherein the content on the primary level includes articles, videos, audio files, podcasts, live webinars, pre-recorded webinars, audio courses, audio courses with written transcripts, and other forms of electronic media content.

In some embodiments, the invention includes a centralized system comprising of a software platform comprising a primary level and a secondary level, wherein any changes or updates to the primary level are automatically applied to the entire secondary level, wherein the primary level comprises of a central entity, wherein the secondary level comprises of at least one subdomain, wherein the subdomains operate and act independently from all other subdomains, wherein content is stored within the central entity, and wherein access to the system is provided to a user with a user account, wherein the content on the secondary level includes articles, videos, audio files, podcasts, live webinars, pre-recorded webinars, audio courses, audio courses with written transcripts, and other forms of electronic media content.

In some embodiments, the invention includes a centralized system comprising of a software platform comprising a primary level and a secondary level, wherein any changes or updates to the primary level are automatically applied to the entire secondary level, wherein the primary level comprises of a central entity, wherein the secondary level comprises of at least one subdomain, wherein the subdomains operate and act independently from all other subdomains, wherein content is stored within the central entity, and wherein access to the system is provided to a user with a user account, wherein the content on the primary level and secondary level includes articles, videos, audio files, podcasts, live webinars, pre-recorded webinars, audio courses, audio courses with written transcripts, and other forms of electronic media content.

In general, one innovative aspect of the subject matter described in this specification can be embodied as a method of delivery transmitting electronic material, comprising of a primary level and a secondary level, wherein any changes or updates to the primary level are automatically applied to the entire secondary level, wherein the primary level comprises of a central entity, wherein the secondary level comprises of at least one subdomain, wherein the subdomains operate and act independently from all other subdomains, wherein content is stored within the central entity, and wherein access to the system is provided to a user with a user account.

In some embodiments, the invention includes a method comprising of primary level and a secondary level, wherein any changes or updates to the primary level are automatically applied to the entire secondary level, wherein the primary level comprises of a central entity, wherein the secondary level comprises of at least one subdomain, wherein the subdomains operate and act independently from all other subdomains and wherein content is stored within the central entity, wherein access to the system is provided to a user with a user account, and wherein the access the user account has to the primary level and secondary levels is customizable.

In some embodiments, the invention includes a method comprising of primary level and a secondary level, wherein any changes or updates to the primary level are automatically applied to the entire secondary level, wherein the primary level comprises of a central entity, wherein the secondary level comprises of at least one subdomain, wherein the subdomains operate and act independently from all other subdomains and wherein content is stored within the central entity, wherein access to the system is provided to a user with a user account, wherein the access the user account has to the primary level and secondary levels is customizable, and further wherein the user account information is tracked and anonymized.

In some embodiments, the invention includes a method comprising of primary level and a secondary level, wherein any changes or updates to the primary level are automatically applied to the entire secondary level, wherein the primary level comprises of a central entity, wherein the secondary level comprises of at least one subdomain, wherein the subdomains operate and act independently from all other subdomains and wherein content is stored within the central entity, wherein access to the system is provided to a user with a user account, wherein the access the user account has to the primary level and secondary levels is customizable, and wherein the content on the primary level and secondary level includes articles, videos, audio files, podcasts, live webinars, pre-recorded webinars, audio courses, audio courses with written transcripts, and other forms of electronic media content.

### BRIEF DESCRIPTION OF THE FIGURES

A full and enabling disclosure of the present invention, including the best mode thereof, directed to one of ordinary skill in the art, is set forth in the specification, which makes reference to the appended drawings in, which:

FIG. 1 is a representation of the invention, wherein exemplary embodiments of the entire system 10, the primary level 20, secondary level 30, and subdomains 35 are shown.

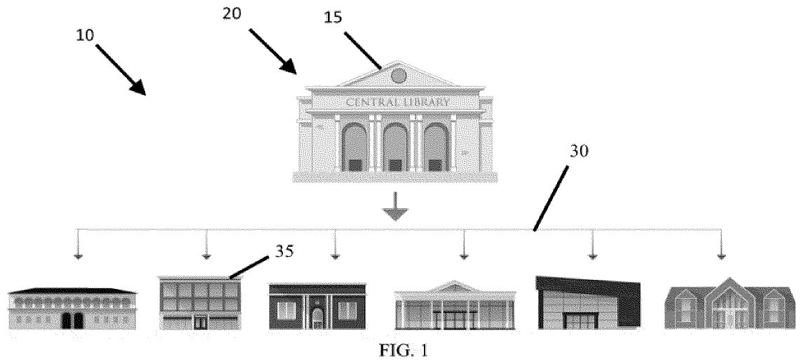

FIG. 2 is a view of the dashboard 40, wherein content available to the specific user account is shown.

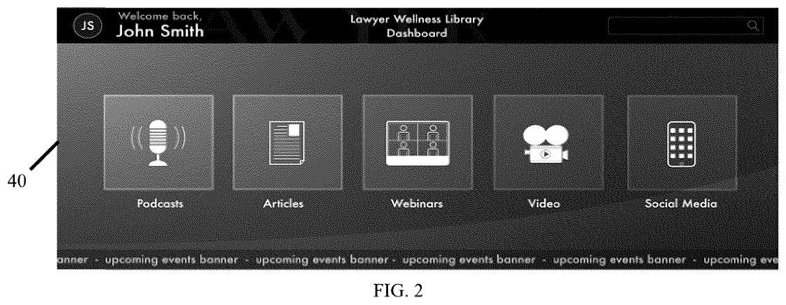

Repeat use of reference characters in the present specification and drawings is intended to represent the same or analogous features or elements of the present invention.

### DETAILED DESCRIPTION

Reference now will be made in detail to the embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as conic within the scope of the appended claims and their equivalents.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

In accordance with the present invention, a content management device, method and system is provided that allows user account's access to content in a manner that is uniquely curated, integrated, and stratified, allowing further improvements in delivering, controlling and updating both the electronic content and the content management system, device, and method itself.

As shown throughout the figures, the content management system 10 includes at least two levels. The first level is the primary level 20. The primary level 20 is superior in hierarchy to all other levels of the system including the secondary level 30. The primary level 20 provides the secondary level 30 and all the subdomains of the secondary level 35 access to the system. The primary level 20 also enables updating of the entire system 10. All updates made to the primary level 20 are reflected and incorporated into all other levels including, but not limited to, the secondary level 30. The primary level 20 includes a central entity 15 or in some embodiments a central library 15. The central entity 15 provides storage for electronic material. In some embodiments, the central entity will provide storage and enablement to the system 10 as a whole. This enablement will include the creation and functionality of user accounts that may access the system 10.

The secondary level 30 comprises of subdomains 35. The subdomains 35 can represent or be assigned to various groups, individuals, government agencies or any entity. Subdomains 35 can be designated for specific law schools, law firms, non-profit entities, libraries, courts and websites or communities of these identified groups. Although subdomains are often for entities exceeding more than one individual, this is not required. For example, in some embodiments an individual user account can be established as a subdomain 35. In some embodiments, every user account is a separate subdomain 35. In embodiments wherein every user account is a separate subdomain 35, the characteristics of each subdomain 35 may be different and controlled by either the primary level 20 or the central entity 25 or both.

The primary level 20 is connected and integrated with the secondary level 30. In some embodiments the connection between the primary level 20 and the secondary level 30 is enabled by a connection being formed between the central entity 15 and the subdomains 35.

The system 10 controls the access of each individual user account. The access of the individual user account is controlled in two ways. First, access is controlled by providing settings on which specific levels the individual user account is enabled or allowed to access. Second, access is controlled by actions that user accounts are allowed to take at each level. For example, some user accounts may only view content, while other user accounts will have the ability to edit files, while other user accounts will have the ability to upload files and other user accounts will have the ability to edit and upload files. User accounts are also controlled by what specific actions these user accounts can make and to what level. For example some user accounts that have the ability to upload to the secondary level 30 may not be able to do so to the primary level 20. This variation in ability based on level can occur in any possibility between the two levels of primary level 20 and secondary level 30, and the three actions of access content, edit content, and upload content. A non-limiting illustration would be wherein some user accounts may have the ability to upload, edit, and access content on the secondary level 30 but may only access and upload content to the primary level 10. Another non-limiting illustration would be wherein some user accounts may have the ability to upload and access content on the secondary level 30 but may only access content at the primary level 10. Any combination of these 3 actions (access, edit, and upload content) and 2 levels (primary 20 and secondary 30) are possible for at least one or more user accounts within the system 10.

Access to the ability to alter the settings such as the settings for the overall system 10, the primary level 20, and/or the secondary level 30, are also controlled by the specific user account. Additionally, access to features of the level does not mean access to the same features for the individual entities, such as the central entity 15 or the subdomains 35. For example, some user accounts may have access to setting controls for a specific subdomain 35 but not for the overall system 10, the primary level 20, or the secondary level 30. In other cases, some user accounts may have access to setting controls for the entire secondary level 30 and one or more subdomains 35 but not the primary level 20.

The system 10 is created with the innovative aspect of making all the subdomains 35 independent, from all other subdomains 35 within the system 10. This allows a single sub domain to update itself or update its content and not necessitate an update for all other domains. Moreover, this system allows each subdomain 35 to innovate, update and advance at their own pace. The system 10 would allow subdomains 35 to never update individually and only be subject to primary level 20 updates. As stated above, the updates of the primary level 20 are integrated into the secondary level 30 and all applicable subdomains 35. In some embodiments, the updates to the central entity 15, the primary level 20, the secondary level 30, the subdomains 35 or updates to any combination of these elements are automated.

The system 10 further provides the user a graphical user interface (GUI), referred to as the dashboard 40. The dashboard 40 provides the user of an account the means to access the content their user account is enabled and/or allowed to access. The dashboard 40 may be substantially different depending on the user account being represented. In some embodiments the individual subdomains 35 are individually represented. In some embodiments all of the content of all the subdomains 35 are integrated into categories allowing easier access.

The system 10 has the capability to track the activity of every user account in real time. The system 10 has the capability to track the activity of every user account in real time and anonymize all user account activity data. In some embodiments, the system 10 will limit the tracking and/or anonymizing of user account activity data to the activity of one or more specific user accounts. In some embodiments, the system 10 can limit the type of data tracked and anonymized data associated with one or more user accounts. In some embodiments the user accounts are anonymized in a manner so they are not discoverable or retrievable by the system 10 or primary level 20. In some embodiments the user accounts are anonymized in a manner so they are not discoverable or retrievable by the subdomains 35 or the secondary level 30. In some embodiments the user accounts are anonymized in a manner so they are not discoverable or retrievable by the system 10, the primary level 20, the subdomains 35, or the secondary level 30. Any tracking by system 10 can also be completed by the central entity 15 or the principal level 20. The system 10 can track individual trends, localized trends, group trends and other trends based on a specific segment or population of the total user accounts. The system 10 can also track trends amongst all of the user accounts of the system 10.

In some embodiments advertisements are incorporated into the invention wherein the user accounts of the system 10 are shown advertisements while accessing the system 10. In some embodiments of the invention, the selection of the advertisements is based on the anonymized user account activity data of the user account viewing said selected advertisement. In some embodiments of the invention, the selection of the advertisements presented to the user account is based on the trends of the anonymized user account activity data of more than one user account and/or an account not associated with the viewer of the advertisement. In some embodiments of the invention, the selection of the advertisements is not based on or in any way due to the activity of the user account viewing the advertisement.

In some embodiments electronic media such as articles, videos, audio files, podcasts, live webinars, pre-recorded webinars, audio courses, audio courses with written transcripts, and other forms of electronic media content are stored within the central entity 15. In some embodiments electronic media such as articles, videos, audio files, podcasts, live webinars, pre-recorded webinars, audio courses, audio courses with written transcripts, and other forms of electronic media content are stored within the primary level 20. In some embodiments electronic media such as articles, videos, audio files, podcasts, live webinars, pre-recorded webinars, audio courses, audio courses with written transcripts, and other forms of electronic media content are stored within the secondary level 30. In some embodiments electronic media such as articles, videos, audio files, podcasts, live webinars, pre-recorded webinars, audio courses, audio courses with written transcripts, and other forms of electronic media content are stored within the subdomains 35. In some embodiments electronic media such as articles, videos, audio files, podcasts, live webinars, pre-recorded webinars, audio courses, audio courses with written transcripts, and other forms of electronic media content are on any combination of the central entity 15, the primary level 20, the secondary level 30, or the subdomains 35,

What is claimed is:

1. A system comprising of a software platform comprising of a primary level and a secondary level, wherein any changes or updates to the primary level are automatically applied to the entire secondary level, wherein the primary level comprises of a central entity, wherein the secondary level comprises of at least one subdomain, wherein the subdomains operate and act independently from all other subdomains, wherein content is stored within the central entity, and wherein access to the system is provided to a user with a user account.

2. The system of claim 1, wherein the access the user account has to the primary level and secondary levels is customizable.

3. The system of claim 2, wherein the system includes a dashboard, wherein the access associated with the user account is shown on a dashboard.

4. The system of claim 1, wherein the system tracks and anonymizes all activity history of all user accounts in an individual manner.

5. The system of claim 4, further comprising sections designed to display advertisements to a user account as the system is accessed by the user account.

6. The system of claim 5, wherein the system selects advertisements to display to users and the selection is based on the user's individual activity history.

7. The system of claim 1, wherein the system tracks and anonymizes some of the activity history of the user account.

8. The system of claim 1, wherein the content on the primary level includes articles, videos, audio files, podcasts, live webinars, pre-recorded webinars, audio courses, audio courses with written transcripts, and other forms of electronic media content.

9. The system of claim 1, wherein the content on the secondary level includes articles, videos, audio files, podcasts, live webinars, pre-recorded webinars, audio courses, audio courses with written transcripts, and other forms of electronic media content.

10. The system of claim 1, wherein the content on the primary level and secondary level includes articles, videos, audio files, podcasts, live webinars, pre-recorded webinars, audio courses, audio courses with written transcripts, and other forms of electronic media content.

11. A method of delivery curated material, comprising of a primary level and a secondary level, wherein any changes or updates to the primary level are automatically applied to the entire secondary level, wherein the primary level comprises of a central entity, wherein the secondary level comprises of at least one subdomain, wherein the subdomains operate and act independently from all other subdomains, wherein content is stored within the central entity, and wherein access to the system is provided to a user with a user account.

12. The method of claim 11, wherein the access the user account has to the primary level and secondary levels is customizable.

13. The method of claim 12, wherein the user account information is tracked and anonymized.

14. The method of claim 11, wherein the content on the primary level and secondary level includes articles, videos, audio files, podcasts, live webinars, pre-recorded webinars, audio courses, audio courses with written transcripts, and other forms of electronic media content.
